(19) United States
(12) Patent Application Publication
(10) Pub. No.: US 2026/0094453 A1
(43) Pub. Date: Apr. 2, 2026

(54) LANE LINE DETECTION METHOD AND SYSTEM THEREOF

(71) Applicant: National Taipei University of Technology, Taipei (TW)

(72) Inventors: XIU-ZHI CHEN, Taipei (TW); YEN-LIN CHEN, Taipei (TW); CHEN-YU YANG, Taipei (TW); CHIH-SHENG HUANG, Taipei (TW); PENG-HSING WEN, Taipei (TW)

(21) Appl. No.: 18/904,001

(22) Filed: Oct. 1, 2024

(51) Int. Cl. G06V 20/56; G06V 10/24; G06V 10/75

(52) U.S. Cl. CPC G06V 20/588; G06V 10/245; G06V 10/751; G06V 2201/07

(57) ABSTRACT

The present invention relates to a lane line detection method, including: extracting multiple deep features from an image by a deep feature extractor; adopting the image and the deep features by a primary algorithm model to generate a first error value, and returning the first error value to the deep feature extractor; adopting the image and the deep features by an auxiliary algorithm model to generate a second error value, and returning the second error value to the deep feature extractor; adjusting the extracted deep features by the deep feature extractor according to the first error value and the second error value. And the lane line detection result can be obtained by using only the deep feature extractor and the primary algorithm model.

### FIELD OF THE INVENTION

The present invention relates to a method of image processing, specifically to a lane line detection method and a system thereof.

### BACKGROUND OF THE INVENTION

Lane line detection is one of the critical techniques in autonomous vehicles and advanced driver assistance systems (ADAS). Whether in general driving scenarios or autonomous driving situations, lane lines serve as an important reference for drivers or autonomous systems while driving. For driver-participated assistance systems, lane line detection not only provides information about the road but also helps drivers to keep the vehicle within the correct lane.

In addition to the commonly seen straight and curved lane lines, there are some more specialized types of lane lines, such as the Y-shaped exit wedge lines, which is typically used on highways or road intersections, and the inverted V-shaped entrance wedge lines, which is used to guide the vehicles from merging the lanes into the main road. Therefore, when conducting lane line detection, it is necessary to consider the differences in lane line types and handle the lane lines appropriately to obtain accurate lane line detection results.

Existing lane line detection methods have issues with low detection efficiency and low detection accuracy in certain road scenarios, such as, when lighting is severely obstructed, or when there are significant changes in lighting conditions, or when encountering special lane line types. The lane line detection method proposed in this disclosure not only can accurately identify lane lines on general roads but also maintain detection efficiency and stability when different lane line types appear, achieving higher detection efficiency.

### SUMMARY OF THE INVENTION

In one embodiment, this disclosure provides a lane line detection method, including: extracting multiple deep features from an image by a deep feature extractor; adopting the image and the deep features by a primary algorithm model to generate a first error value, and returning the first error value to the deep feature extractor; adopting the image and the deep features by an auxiliary algorithm model to generate a second error value, and returning the second error value to the deep feature extractor; adjusting the extracted deep features by the deep feature extractor according to the first error value and the second error value.

Preferably, the method further comprises generating a lane line detection result by the deep feature extractor and the primary algorithm model.

Preferably, the step of adopting the image and the deep features by a primary algorithm model to generate a first error value, and returning the first error value to the deep feature extractor further includes: establishing a coordinate system on the image, comprising multiple vertical axes and multiple horizontal axes; determining whether the vertical and horizontal axes intersect with a target region in the image; performing a gridding process regarding coordinates that intersect with the target region to obtain multiple target grids; connecting the multiple target grids to obtain a first lane line computation result; comparing the first lane line computation result with label data of the image to obtain the first error value.

Preferably, the step of performing a gridding process regarding coordinates that intersect with the target region to obtain multiple target grids further includes: establishing a grid surface on the image; mapping the coordinates that intersect with the target region onto the grid surface to obtain the target grids.

Preferably, the step of adopting the image and the deep features by an auxiliary algorithm model to generate a second error value, and returning the second error value to the deep feature extractor further includes: segmenting the image to obtain multiple target meshes, wherein the target meshes correspond to the target region in the image; designating one target mesh among the multiple target meshes as a reference mesh, obtaining an offset value between the reference mesh and a preceding adjacent mesh, the offset value between the reference mesh and a succeeding adjacent mesh, obtaining a distance value from the reference mesh to a front-end point, and the distance value from the reference mesh to a rear-end point, wherein a distance between the preceding adjacent mesh and the reference mesh, and a distance between the succeeding adjacent mesh and the reference mesh are configured to be as a predetermined distance; obtaining the offset values of all target meshes relative to the corresponding preceding adjacent mesh and succeeding adjacent mesh, and obtaining the distance values of all target meshes regarding the corresponding front-end point and rear-end point; connecting the multiple target meshes to obtain the second lane line computation result; comparing the second lane line computation result with the label data of the image to obtain the second error value.

Preferably, the method further comprises selecting one of the target meshes as a reference point, and adopting the reference point as the center to form a target mesh macro with a specified distance as the radius to include all target meshes within that radius.

In another embodiment, this disclosure further provides a lane line detection system, including: an image capturing device; a computing device, wherein the computing device includes: a deep feature extractor configured to receive an image from the image capturing device and extract multiple deep features from the image; a primary algorithm model, wherein the primary algorithm model is configured to adopt the image and the deep features to generate a first error value and to return the first error value to the deep feature extractor; an auxiliary algorithm model, wherein the auxiliary algorithm model is configured to adopt the image and the deep features to generate a second error value and to return the second error value to the deep feature extractor; wherein the deep feature extractor adjusts the extracted deep features according to the first error value and the second error value.

Preferably, the system further includes a decoder configured to output a lane line detection result, wherein the lane line detection result is generated by the deep feature extractor and the primary algorithm model.

Preferably, the primary algorithm model includes: an existence branch configured to establish a coordinate system, having multiple vertical axes and multiple horizontal axes, on the image, and to determine whether the vertical and horizontal axes intersect with a target region in the image; a positioning branch configured to perform a gridding process regarding coordinates that intersect with the target region to obtain multiple target grids, to connect the multiple target grids to obtain a first lane line computation result, and to compare the first lane line computation result with label data of the image to obtain the first error value.

Preferably, the auxiliary algorithm model further includes: a segmentation head configured to segment the image to obtain multiple target meshes, wherein the target meshes correspond to the target region in the image; a transfer head configured to designate one target mesh among the multiple target meshes as a reference mesh, to obtain an offset value between the reference mesh and a preceding adjacent mesh, the offset value between the reference mesh and a succeeding adjacent mesh, wherein a distance between the preceding adjacent mesh and the reference mesh and a distance between the succeeding adjacent mesh and the reference mesh are configured to be as a predetermined distance; a distance head configured to obtain a distance value from the reference mesh to a front-end point, and the distance value from the reference mesh to a rear-end point, to connect the multiple target meshes to obtain the second lane line computation result, and to compare the second lane line computation result with the label data of the image to obtain the second error value.

In summary, the lane line detection method provided in this disclosure allows the primary algorithm model and auxiliary algorithm model to share information during the training phase and jointly train the deep feature extractor. Therefore, the deep feature extractor may obtain the strengths of both the primary and auxiliary algorithm models. During the inference phase, the auxiliary algorithm model can be removed, allowing the inference results to be carried out solely by using the deep feature extractor and the primary algorithm model. Such that, the efficiency of lane line detection may be improved.

### BRIEF DESCRIPTION OF THE DRAWINGS

FIG. 1 is a system diagram of the lane line detection system in accordance with one embodiment of the present disclosure.

FIG. 2 is a flowchart of the lane line detection method in accordance with one embodiment of the present disclosure.

FIG. 3 is a system diagram of the primary algorithm model in accordance with one embodiment of the present disclosure.

FIG. 4 is a flowchart of the computing process of the primary algorithm model in accordance with one embodiment of the present disclosure.

FIG. 5 is a system diagram of the auxiliary algorithm model in accordance with one embodiment of the present disclosure.

FIG. 6 is a flowchart of the computing process of the auxiliary algorithm model in accordance with one embodiment of the present disclosure.

### DETAILED DESCRIPTION OF THE INVENTION

In order to make the aforementioned and/or other objectives, effects, and features of the present invention more apparent and easier to understand, the following will provide a detailed explanation through the example of a preferred embodiment.

Please refer to FIG. 1, FIG. 1 is a system diagram of the lane line detection system in accordance with one embodiment of the present disclosure. The lane line detection system 100 includes an image capturing device 10 and a computing device 20. The image capturing device 10 is configured to capture road images. For example, the image capturing device 10 may be a camera or a video recorder, but this disclosure is not limited thereto.

The computing device 20 includes a deep feature extractor 21, a primary algorithm model 22, an auxiliary algorithm model 23, and a decoder 24. After the image capturing device 10 captures the road image, the image capturing device 10 inputs the road image into the deep feature extractor 21. The deep feature extractor 21 is configured to extract multiple deep features from the road image. The deep feature extractor 21 is a backbone network. For example, the deep feature extractor 21 may be a ResNet-34 model, but this disclosure is not limited thereto. In one embodiment of this disclosure, the deep features extracted by the deep feature extractor 21 may include image-related information such as luminance information, chrominance information, grayscale information, and so on, but this disclosure is not limited thereto.

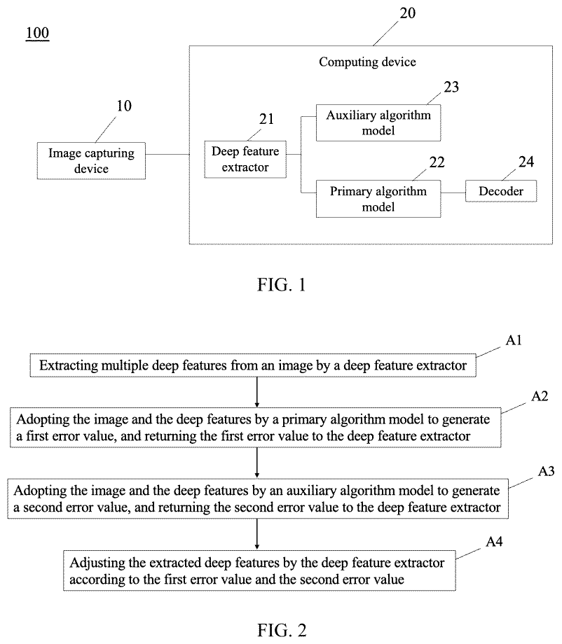

Please refer to FIG. 2, FIG. 2 is a flowchart of the lane line detection method in accordance with one embodiment of the present disclosure. The specific steps of the method are as follows.
In step A1, extracting multiple deep features from an image by a deep feature extractor.
In step A2, adopting the image and the deep features by a primary algorithm model to generate a first error value, and returning the first error value to the deep feature extractor.
In step A3, adopting the image and the deep features by an auxiliary algorithm model to generate a second error value, and returning the second error value to the deep feature extractor.
In step A4, adjusting the extracted deep features by the deep feature extractor according to the first error value and the second error value.

First, after the image capturing device 10 inputs the captured road image into the computing device 20, the deep feature extractor 21 within the computing device 20 extracts multiple deep features from the input road image using predetermined parameters. The road image and the multiple deep features are then input into the primary algorithm model 22 and the auxiliary algorithm model 23, respectively. The primary algorithm model 22 and the auxiliary algorithm model 23 perform computations using the obtained road image and deep features to generate the first error value and the second error value, respectively.

Specifically, after the road image is input into the computing device 20, the computing device 20 encodes training labels for the road image to obtain label data of the road image. After the primary algorithm model 22 and the auxiliary algorithm model 23 perform computations to obtain the predicted results of the lane lines, the predicted results are compared with the label data to obtain the first error value and the second error value, respectively.

Then, the primary algorithm model 22 and the auxiliary algorithm model 23 respectively return the generated first error value and second error value to the deep feature extractor 21 to train the deep feature extractor 21. That is, the deep feature extractor 21 adjusts the parameters used for extracting deep features according to the returned first error value and second error value. Once the deep feature extractor 21 finishes the adjustments, this round of training is completed. In one example, after receiving the first error value and the second error value, the deep feature extractor 21 may use the backpropagation algorithm to adjust the parameters used for extracting deep features.

When the deep feature extractor 21 adjusts the parameters used to extract deep features, the deep feature extractor 21 adopts both the first error value generated by the primary algorithm model 22 and the second error value generated by the auxiliary algorithm model 23. As a result, the deep feature extractor 21 can learn from the computational outcomes of both the primary algorithm model 22 and the auxiliary algorithm model 23, thereby incorporating the characteristics of both models.

Then, at the beginning of the next training session, a different road image is input into the deep feature extractor 21. At this time, the deep feature extractor 21 uses the adjusted parameters to extract deep features from the road image, and the road image and the extracted deep features are input into the primary algorithm model 22 and the auxiliary algorithm model 23. After computing, the primary algorithm model 22 and the auxiliary algorithm model 23 then return the generated first error value and second error value to the deep feature extractor 21 to further train the deep feature extractor 21 to complete this round of training. This step is repeated until the training phase is completed.

By using the first error value generated by the primary algorithm model 22 and the second error value generated by the auxiliary algorithm model 23 to train the deep feature extractor 21, the deep feature extractor 21 may incorporate the characteristics of both the primary algorithm model 22 and the auxiliary algorithm model 23. Therefore, during inference phase, the auxiliary algorithm model 23 can be removed, and the inference can be conducted by using only the deep feature extractor 21 and the primary algorithm model 22. The lane line detection result is then output by the decoder 24. Such that, the computational load of the system may be reduced when conducting inference, and computing efficiency may be increased.

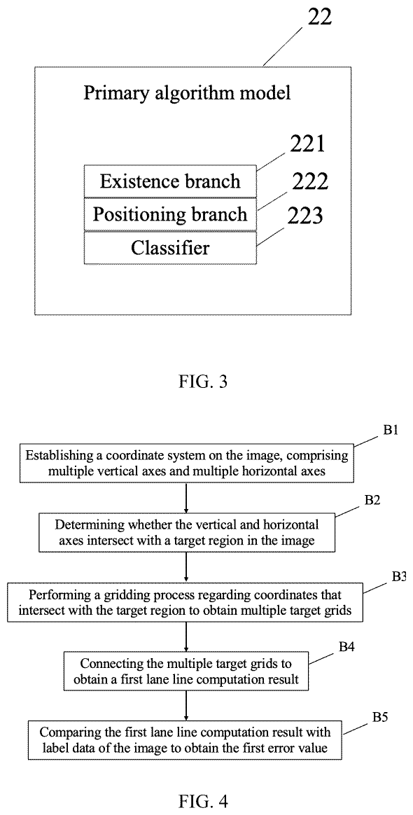

Please refer to FIG. 3, FIG. 3 is a system diagram of the primary algorithm model in accordance with one embodiment of the present disclosure. The primary algorithm model 22 includes an existence branch 221, a positioning branch 222, and a classifier 223. In one embodiment of this disclosure, please refer to FIG. 4, and the computing process of the primary algorithm model is described below.
In step B1, establishing a coordinate system on the image, including multiple vertical axes and multiple horizontal axes.
In step B2, determining whether the vertical and horizontal axes intersect with a target region in the image.
In step B3, performing a gridding process regarding coordinates that intersect with the target region to obtain multiple target grids.
In step B4, connecting the multiple target grids to obtain a first lane line computation result.
In step B5, comparing the first lane line computation result with label data of the image to obtain the first error value.

Specifically, after the road image and deep features are input into the primary algorithm model 22 from the deep feature extractor 21, the existence branch 221 establishes multiple vertical axes and multiple horizontal axes on the input road image to form a coordinate system. Then, the existence branch 221 adopts the input deep features to determine whether each coordinate in the coordinate system intersects with the target region in the road image. In this embodiment, the target region is the lane line in the road image. If the existence branch 221 determines that the coordinates in the coordinate system intersect with the target region, the classifier 223 classifies the coordinate as a target point.

It should be noted that, after forming the coordinate system, the primary algorithm model 22 preliminarily classifies the coordinates, according to the lane line where the coordinates are located at, to distinguish the coordinates into different groups so as to avoid errors. For example, if coordinates (1,1), (2,1), and (2,2) are determined to correspond to the primary lane line on the left side, these coordinates are marked as the same group. Similarly, if coordinates (10,2), (11,3), and (12,4) are determined to correspond to the primary lane line on the right side, these coordinates are marked as the same group. Such that, the errors during lane line computation may be avoided.

The positioning branch 222 creates a grid surface, having a plurality of grids, on the input road image. It should be noted that the size of the grid can be decided based on the actual requirements. A smaller grid provides higher accuracy but requires more computational time. After the positioning branch 222 creates the grids, the positioning branch 222 maps the coordinates of the target points onto the grids. For example, coordinates (1,1), (2,1), (2,2), (3,3), (3,4), (4,4), and (5,4) are coordinates intersecting with the lane line, and these coordinates are classified as the target points by the existence branch 221. If the selected grid is a square with a side length of 3 pixels, the coordinates (1,1), (2,1), and (2,2) correspond to the grid in the first row, first column, the coordinates (3,3), (3,4), and (4,4) correspond to the grid in the second row, second column; and the coordinate (5,4) corresponds to the grid in the second row, third column, such that the target points may be mapped onto the grid surface. Then, the classifier 223 classifies the grids that correspond to target points as the target grids.

By connecting the target grids, the lane line computation result of the primary algorithm model may be obtained. Finally, the lane line computation result is compared with the label data of the road image to obtain the first error value.

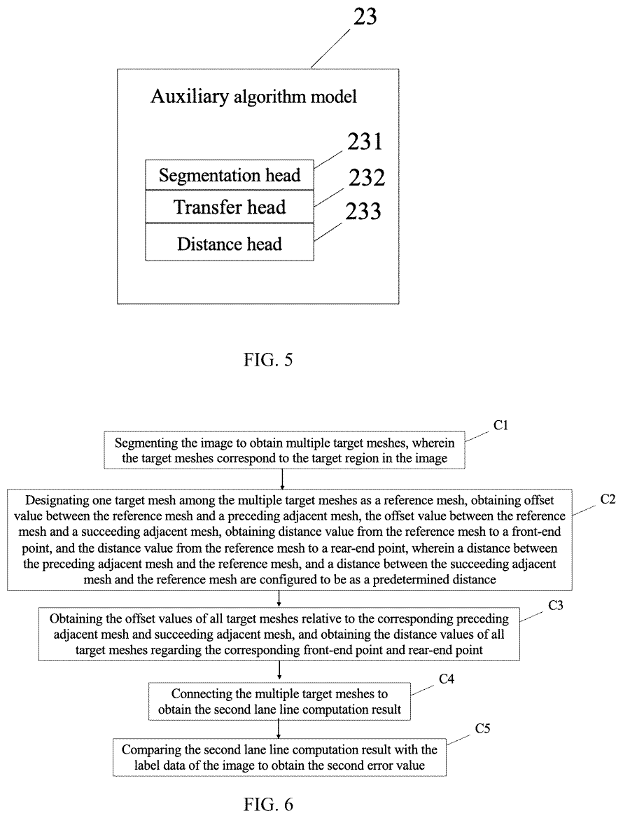

Please refer to FIG. 5, FIG. 5 is a system diagram of the auxiliary algorithm model in accordance with one embodiment of the present disclosure. The auxiliary algorithm model 23 includes a segmentation head 231, a transfer head 232, and a distance head 233. Please refer to FIG. 6, the computing process of the auxiliary algorithm model is as follows.
In step C1, segmenting the image to obtain multiple target meshes, wherein the target meshes correspond to the target region in the image.
In step C2, designating one target mesh among the multiple target meshes as a reference mesh, obtaining an offset value between the reference mesh and a preceding adjacent mesh, the offset value between the reference mesh and a succeeding adjacent mesh, obtaining a distance value from the reference mesh to a front-end point, and the distance value from the reference mesh to a rear-end point, wherein a distance between the preceding adjacent mesh and the reference mesh, and a distance between the succeeding adjacent mesh and the reference mesh are configured to be as a predetermined distance.
In step C3, repeating the previous step to obtain the offset values of all target meshes relative to the corresponding preceding adjacent mesh and succeeding adjacent mesh, and obtaining the distance values of all target meshes regarding the corresponding front-end point and rear-end point.
In step C4, connecting the multiple target meshes to obtain the second lane line computation result.
In step C5, comparing the second lane line computation result with the label data of the image to obtain the second error value.

Specifically, after the road image and deep features are input into the auxiliary algorithm model 23 from the deep feature extractor 21, the segmentation head 231 segments the input image into multiple meshes and uses the deep features to determine whether each mesh corresponds to the target region in the image. If a mesh corresponds to the target region, the mesh is determined as a target mesh. For example, if the target region in the image is the lane line and the segmentation head 231 determines that the meshes located at (3,1), (3,2), (4,2), (5,2), and (6,3) correspond to the lane line, these meshes are identified as target meshes.

The transfer head 232 is configured to obtain the offset values between each target mesh and the corresponding preceding and succeeding target meshes. Specifically, the transfer head 232 designates one of the target meshes as the reference mesh and then obtains the position of the preceding adjacent target mesh and the position of the succeeding adjacent target mesh. The preceding adjacent target mesh and the succeeding adjacent target mesh are located at a predetermined distance from the reference mesh. Subsequently, the offset value between the reference mesh and the preceding adjacent target mesh, and the offset value between the reference mesh and the succeeding adjacent target mesh are computed. By performing the above computations for all target meshes, the offset values between each target mesh and the corresponding preceding and succeeding adjacent target meshes can be obtained. Once the offset values are obtained, the transfer head 232 can determine the relative positional relationship between each target mesh and the corresponding preceding, and succeeding adjacent target meshes. It should be noted that the predetermined distance can be determined based on actual requirements. In one example, the minimum predetermined distance may be one pixel.

Then, the distance head 233 is configured to determine the distances from the target mesh to the front-end point and to the rear-end point of the corresponding lane line. After obtaining the distances between each target mesh and the corresponding front-end point and rear-end point, the relative position of each target mesh on the corresponding lane line can be determined. Such that, the sequential relationship of each target mesh can be obtained.

For example, assuming the predetermined distance is 10 pixels, a first target mesh is 100 pixels away from the front-end point and 130 pixels away from the rear-end point, the distance head 233 may determine that there are 8 target meshes between the first target mesh and the front-end point, and 11 target meshes between the first target mesh and the rear-end point. If the second target mesh is 130 pixels away from the front-end point and 90 pixels away from the rear-end point, the distance head 233 may determine that there are 11 target meshes between the second target mesh and the front-end point, and 7 target meshes between the second target mesh and the rear-end point. If the third target mesh is 110 pixels away from the front-end point and 120 pixels away from the rear-end point, the distance head 233 may determine that there are 9 target meshes between the third target mesh and the front-end point, and 10 target meshes between the third target mesh and the rear-end point. Such that, when the upper edge of the road image is used as the reference, it can be determined that the three target meshes are in a sequence of the first target mesh, the third target mesh, and the second target mesh. By repeating the above steps, the positional order of all target meshes on the corresponding lane line may be determined.

It should be noted that when the road image is input into the auxiliary algorithm model 23, the auxiliary algorithm model 23 undergoes a pre-processing procedure to classify different lane lines by using the training data, so as to distinguish different lane lines, and the positions of the front-end point and rear-end point of each lane line are also annotated in the pre-processing procedure to facilitate the distance head 233 in computing the distance between each target mesh and the corresponding front-end point and rear-end point.

After determining the relative positional and sequential relationships between the target meshes of the same lane line, the lane line computed by the auxiliary algorithm model by sequentially connecting the target meshes. Finally, by comparing the lane line computed by the auxiliary algorithm model with the label data of the image, the second error value can be obtained.

In another embodiment of this disclosure, after the segmentation head 231 obtained the target meshes, the segmentation head 231 may perform a sparsify process regarding the target meshes. Specifically, the segmentation head 231 select one of the target meshes as a reference point, and use the reference point as the center to form a target mesh macro with a specified distance as the radius to include all target meshes within that radius. The next target mesh outside of that radius is then used as the next reference point to perform the sparsifying process, thereby generating multiple target mesh macros along the lane line. During computation, the auxiliary algorithm model 23 adopts the target mesh macros instead of the target mesh to perform the computation, such that the computational load may be reduced, and the calculation efficiency may be improved.

In summary, the lane line detection method provided in this disclosure allows the primary algorithm model and auxiliary algorithm model to share information during the training phase and jointly train the deep feature extractor. Therefore, the deep feature extractor may obtain the strengths of both the primary and auxiliary algorithm models. During the inference phase, the auxiliary algorithm model can be removed, allowing the inference results to be carried out solely by using the deep feature extractor and the primary algorithm model. Such that, the efficiency of lane line detection may be improved.

The above description and explanation are merely illustrative of the preferred embodiments of this creation. Those skilled in the art may make other modifications based on the following defined patent claims and the above description, provided that such modifications remain within the spirit of this creation and fall within the scope of this creation's rights.

What is claimed is:

1. A lane line detection method, comprising:
extracting multiple deep features from an image by a deep feature extractor;
adopting the image and the deep features by a primary algorithm model to generate a first error value, and returning the first error value to the deep feature extractor;
adopting the image and the deep features by an auxiliary algorithm model to generate a second error value, and returning the second error value to the deep feature extractor;
adjusting the extracted deep features by the deep feature extractor according to the first error value and the second error value.

2. The lane line detection method according to claim 1, wherein the method further comprises generating a lane line detection result by the deep feature extractor and the primary algorithm model.

3. The lane line detection method according to claim 2, wherein the step of adopting the image and the deep features by a primary algorithm model to generate a first error value, and returning the first error value to the deep feature extractor further comprises:
establishing a coordinate system on the image, comprising multiple vertical axes and multiple horizontal axes;
determining whether the vertical and horizontal axes intersect with a target region in the image;
performing a gridding process regarding coordinates that intersect with the target region to obtain multiple target grids;
connecting the multiple target grids to obtain a first lane line computation result;
comparing the first lane line computation result with label data of the image to obtain the first error value.

4. The lane line detection method according to claim 3, wherein the step of performing a gridding process regarding coordinates that intersect with the target region to obtain multiple target grids further comprises:
establishing a grid surface on the image;
mapping the coordinates that intersect with the target region onto the grid surface to obtain the target grids.

5. The lane line detection method according to claim 2, wherein the step of adopting the image and the deep features by an auxiliary algorithm model to generate a second error value, and returning the second error value to the deep feature extractor further comprises:
segmenting the image to obtain multiple target meshes, wherein the target meshes correspond to the target region in the image;
designating one target mesh among the multiple target meshes as a reference mesh, obtaining an offset value between the reference mesh and a preceding adjacent mesh, the offset value between the reference mesh and a succeeding adjacent mesh, obtaining a distance value from the reference mesh to a front-end point, and the distance value from the reference mesh to a rear-end point, wherein a distance between the preceding adjacent mesh and the reference mesh, and a distance between the succeeding adjacent mesh and the reference mesh are configured to be as a predetermined distance;
obtaining the offset values of all target meshes relative to the corresponding preceding adjacent mesh and succeeding adjacent mesh, and obtaining the distance values of all target meshes regarding the corresponding front-end point and rear-end point;
connecting the multiple target meshes to obtain the second lane line computation result;
comparing the second lane line computation result with the label data of the image to obtain the second error value.

6. The lane line detection method according to claim 5, wherein the method further comprises selecting one of the target meshes as a reference point, and adopting the reference point as the center to form a target mesh macro with a specified distance as the radius to include all target meshes within that radius.

7. A lane line detection system, comprising:
an image capturing device;
a computing device, wherein the computing device comprises:
a deep feature extractor configured to receive an image from the image capturing device and extract multiple deep features from the image;
a primary algorithm model, wherein the primary algorithm model is configured to adopt the image and the deep features to generate a first error value and to return the first error value to the deep feature extractor;
an auxiliary algorithm model, wherein the auxiliary algorithm model is configured to adopt the image and the deep features to generate a second error value and to return the second error value to the deep feature extractor;
wherein the deep feature extractor adjusts the extracted deep features according to the first error value and the second error value.

8. The lane line detection system according to claim 7, wherein the system further comprises a decoder configured to output a lane line detection result, wherein the lane line detection result is generated by the deep feature extractor and the primary algorithm model.

9. The lane line detection system according to claim 8, wherein the primary algorithm model comprises:
an existence branch configured to establish a coordinate system, having multiple vertical axes and multiple horizontal axes, on the image, and to determine whether the vertical and horizontal axes intersect with a target region in the image;
a positioning branch configured to perform a gridding process regarding coordinates that intersect with the target region to obtain multiple target grids, to connect the multiple target grids to obtain a first lane line computation result, and to compare the first lane line computation result with label data of the image to obtain the first error value.

10. The lane line detection system according to claim 8, wherein the auxiliary algorithm model further comprises:
a segmentation head configured to segment the image to obtain multiple target meshes, wherein the target meshes correspond to the target region in the image;
a transfer head configured to designate one target mesh among the multiple target meshes as a reference mesh, to obtain an offset value between the reference mesh and a preceding adjacent mesh, the offset value between the reference mesh and a succeeding adjacent mesh, wherein a distance between the preceding adjacent mesh and the reference mesh and a distance between the succeeding adjacent mesh and the reference mesh are configured to be as a predetermined distance;
a distance head configured to obtain a distance value from the reference mesh to a front-end point, and the distance value from the reference mesh to a rear-end point, to connect the multiple target meshes to obtain the second lane line computation result, and to compare the second lane line computation result with the label data of the image to obtain the second error value.
